(19) United States
(12) Patent Application Publication
(10) Pub. No.: US 2026/0126292 A1
(43) Pub. Date: May 7, 2026

(54) VISUAL IMU BASED RELATIVE ATTITUDE MEASURING SYSTEM

(71) Applicant: Honeywell International Inc., Charlotte, NC (US)

(72) Inventors: Xiao Cao, Shanghai (CN); Juan Hu, Shanghai (CN); Siqin Yu, Shanghai (CN)

(73) Assignee: Honeywell International Inc., Charlotte, NC (US)

(21) Appl. No.: 18/937,658

(22) Filed: Nov. 5, 2024

(51) Int. Cl. G01C 21/16; G06T 7/73

(52) U.S. Cl. CPC G01C 21/1656; G06T 7/73; G06T 2207/10004; G06T 2207/20084; G06T 2207/30252

(57) ABSTRACT

A system comprises a chassis of a vehicle, a movable member movably coupled to the chassis, a feature board attached to the vehicle, and a visual IMU mounted on the vehicle. The visual IMU includes a camera having a field of view that includes the feature board. An auxiliary IMU is also mounted on the vehicle. A processor onboard the vehicle is in communication with the visual IMU and auxiliary IMU. The processor hosts a program module including a visual-inertial algorithm that performs a process comprising: receive visual information from the camera, the visual information including features detected in images of the feature board captured by the camera; receive inertial measurements from visual IMU and the auxiliary IMU, the inertial measurements including acceleration data and angular rate data; and estimate orientation of the movable member with respect to the chassis by integrating the visual information with the inertial measurements.

### BACKGROUND

Construction machines are widely used in industrial applications such as in mining and construction. A junior operator usually cannot accurately operate a blade or bucket in a dozer or excavator. Automatic driving system providers have provided several off-the-shelf products, which are integrated in construction machines and help operators auto-operate the blade or bucket in many applications. One of the most important technical enablers is attitude sensing of each part of a construction machine. For example, a dozer usually includes a chassis, C-frame, and blade. In some existing designs, a dual-antenna Global Navigation Satellite System (GNSS) receiver is used to acquire a heading of the blade, and an extra tilt sensor is used to acquire the pitch/roll angle of the blade. These designs also need to install a GNSS receiver and a tilt sensor in the chassis to calculate the relative movement between the chassis and blade, to sense the relative motion and provide a control solution.

The use of a GNSS receiver and tilt sensor in construction machines have several disadvantages. These include high price, and the need for extra masts for dual-antenna installation, which hampers operations and can be easily damaged. In addition, these designs cannot support operations in GNSS denied scenarios (e.g., in a tunnel).

### SUMMARY

A system comprises a chassis of a vehicle; a movable member movably coupled to the chassis; a feature board attached to the vehicle; and a visual inertial measurement unit (IMU) mounted on the vehicle. The visual IMU includes a camera and a first set of inertial sensors, with the camera configured to have a field of view that includes the feature board. An auxiliary IMU is mounted on the vehicle, with the auxiliary IMU including a second set of inertial sensors. At least one processor onboard the vehicle is in operative communication with the visual IMU and the auxiliary IMU. The at least one processor hosts a program module including a visual-inertial algorithm operative to perform a process that comprises: receive visual information from the camera, the visual information including features detected in images of the feature board captured by the camera; receive inertial measurements from visual IMU and the auxiliary IMU, the inertial measurements including acceleration data and angular rate data; and estimate orientation of the movable member with respect to the chassis by integrating the visual information with the inertial measurements.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a block diagram of a relative attitude measuring system for a vehicle, according to one embodiment;

FIG. 2 is a flow diagram of an operational method for a relative attitude measuring system, according to one implementation;

FIG. 3A is a flow diagram of a tight coupling function that can be performed by the operational method of FIG. 2 in one alternative implementation; and

FIG. 3B is a flow diagram of a loose coupling function that can be performed by the operational method of FIG. 2, in another alternative implementation.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

A system and method for a visual inertial measurement unit (IMU) based relative attitude measuring system, are described herein. In general, the present techniques are applicable to relative heading/attitude measuring systems, where there are at least two bodies that have up to three degree of freedom in roll, pitch and yaw, with the bodies physically coupled such that one body is within a field of view of another body.

The present approach employs a visual-inertial odometry (VIO) system for estimating a pose by integrating visual information from one or more cameras with inertial measurements from one or more inertial measurement unit (IMUs). The present approach can use either a tightly coupled VIO system or a loosely coupled VIO system.

In the tightly coupled VIO system, the visual information (features detected in images) and inertial measurements (acceleration and angular rate) are integrated at an early stage in the state estimation process. This means that raw data from both the camera and the IMU are combined and processed together in a single optimization filter. In the loosely coupled VIO system, the visual information and inertial measurements are processed independently to estimate motion before these estimates are fused in a later stage. Typically, the camera data is used to perform visual odometry, estimating motion by tracking visual features across successive images. Separately, the IMU data is processed to estimate changes in pose based on inertial measurements. Finally, the estimates from both processes are merged, such as by using a filtering approach (e.g., Kalman filter), to produce the overall pose estimate.

For the visual information, features detected in images can be processed using either traditional computer vision methods, or artificial intelligence (AI) algorithms such as deep neural networks (DNNs). In addition, traditional pose (position and rotation) estimation algorithms, or DNN-based algorithms can be employed to do end to end pose estimation.

In some embodiments, a visual IMU is installed in a chassis of a vehicle, and a feature board is installed on a movable member coupled to and opposite the chassis. The visual IMU includes a camera and a plurality of inertial sensors (IMU), with the camera configured to have a field of view that includes the feature board. The visual IMU is configured to track the feature board and calculate a relative attitude of the movable member. In other embodiments, the visual IMU is installed on the movable member, and the feature board is installed on the chassis.

An installation boresight between the camera and IMU can be calibrated in the factory. After installation of the visual IMU and an auxiliary IMU on the vehicle, the boresight between the visual IMU and auxiliary IMU can be calibrated on-site. The calibrated boresight value (roll/pitch/yaw offset) and initial image of the feature board can be recorded in a flash memory of a processor. These can be used to initialize a relative heading/attitude in a next normal operation (e.g., original installation boresight and relative rotation between original calibration image and current image).

The present approach can be implemented in auto-driving/control systems of vehicles such as construction machines. The combination of camera and IMU in the visual IMU can provide accurate and robust state estimation in different situations by using flexible visual algorithms, such as classic optical algorithms or AI algorithms, and loosely or tightly coupled navigation algorithms.

In one example embodiment, a visual IMU is installed in a chassis of a dozer, and a feature board (e.g., chessboard) is installed on the back of a blade of the dozer. This embodiment can provide absolute pitch/roll of the chassis and relative attitude (pitch/roll/yaw) between the chassis and blade. An automatic driving system can leverage the mechanical structure of the dozer and the relative attitude from the visual IMU, to accurately estimate the position and attitude of the blade. The present approach is also applicable to other heavy construction machines, which need to sense the relative attitude/movement of a movable member.

In addition, AI based algorithms can be used for image low-light augmentation and super-resolution augmentation, to improve the performance of the present system in degraded visual environments.

The present system provides several advantages, including: higher accuracy, with lower attitude drift and no accumulated error; simplified installation and robust performance in complex environments such as GNSS-denied scenarios; and cost-effectiveness.

Further details of various embodiments are described hereafter and with reference to the drawings.

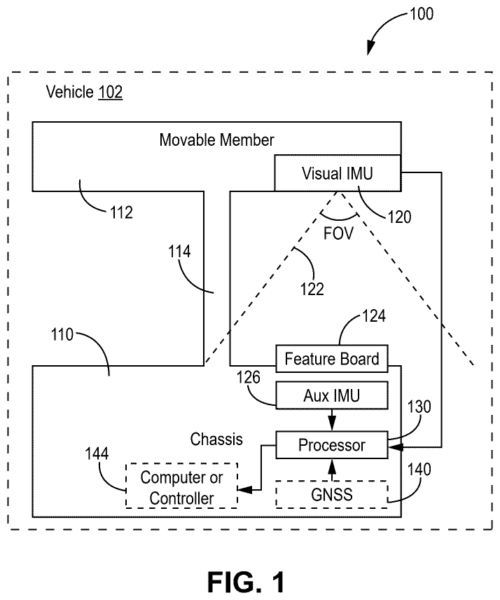

FIG. 1 is a block diagram of a relative attitude measuring system 100 for a vehicle 102, according to one embodiment. The vehicle 102 can include a construction machine vehicle, such as a dozer, excavator, or the like. The vehicle 102 generally comprises a chassis 110, and a movable member 112 such as a blade or bucket, movably connected to chassis 110 through a mechanical arm structure 114, such as a push arm, tilt cylinder, or lift cylinder.

In one embodiment, a visual inertial measurement unit (IMU) 120 is mounted on movable member 112. The visual IMU 120 includes a vision sensor such as camera, and a plurality of inertial sensors such as one or more gyroscopes and one or more accelerometers. For example, visual IMU 120 can include three-axis gyroscopes that measure rotational movement about three perpendicular axes (X, Y, Z), and three-axis accelerometers that measure translational movement about three perpendicular axes (X, Y, Z), thereby providing for six degrees of freedom (DOF).

A feature board 124 is attached to chassis 110, such that the camera of visual IMU 120 has field of view (FOV) 122 that includes feature board 124. The feature board 124 is configured to have distinct features, and should be rigid enough to maintain its shape. The feature board 124 has a flat surface with a precisely defined pattern of points or markers, such as black and white squares in a chessboard or checkerboard pattern, unique markers in a ChArUco pattern, or a circular grid. The feature board 124 is located on chassis 110 within the field of view of visual IMU 120 during relative motion.

An auxiliary IMU 126 can also be mounted on chassis 110. The auxiliary IMU 126 includes a plurality of inertial sensors such as one or more gyroscopes and one or more accelerometers. For example, auxiliary IMU 126 can include three-axis gyroscopes and three-axis accelerometers.

In alternative embodiments, feature board 124 can be attached to movable member 112, and visual IMU 120 can be mounted on chassis 110. In this arrangement, feature board 124 is located on movable member 112 so as to be within the field of view of visual IMU 120 during relative motion. The auxiliary IMU 126 can also be mounted in movable member 112.

At least one processor 130 is located in chassis 110, and is in operative communication with visual IMU 120 and auxiliary IMU 126. The processor 130 hosts a program module that includes a visual-inertial algorithm, as described further hereafter. The processor 130 is operative to receive data from visual IMU 120, including image, gyroscope and acceleration data, and data from auxiliary IMU 126, including gyroscope and acceleration data.

In some alternative embodiments, a GNSS receiver 140 can be located in chassis 110 and communicatively coupled with processor 130. When employed, GNSS data from GNSS receiver 140 provides position and heading information such as a true heading, which can be used to eliminate the influence of Earth rotation (about 15°/hr) and provide absolute heading for visual IMU 120 and auxiliary IMU 126. In addition, an onboard computer or controller 144 can also be in operative communication with processor 130. The processor 130 can output relative heading/attitude information between visual IMU 120 and auxiliary IMU 126 to computer or controller 144 by a common data interface, such as a Controller Area Network (CAN), Universal Asynchronous Receiver/Transmitter (UART), or the like.

The processor 130 executes instructions in the program module for running the visual-inertial algorithm by a process comprising receiving visual information from the camera of visual IMU 120, with the visual information including features detected in images of feature board 124 captured by the camera; receiving inertial measurements from the inertial sensors in visual IMU 120 and auxiliary IMU 126, with the inertial measurements including acceleration and angular rate data; and estimating orientation of movable member 112 with respect to chassis 110 by integrating the visual information with the inertial measurements.

In some implementations, the visual-inertial algorithm can be performed by a tightly coupled process in which the visual information and the inertial measurements are combined and processed together in a single optimization filter to estimate the orientation of the movable member 112 with respect to chassis 110. In other implementations, the visual-inertial algorithm can be performed by a loosely coupled process in which the visual information and the inertial measurements are processed independently to provide estimates of the orientation of movable member 112 with respect to chassis 110, before these estimates are fused together.

In some embodiments, the visual information including features detected in images can be processed using conventional computer vision algorithms, such as histogram of oriented gradients (HOG), scale-invariant feature transform (SIFT), or the like. In other embodiments, the visual information including features detected in images can be processed using one or more neural networks, such as deep neural networks.

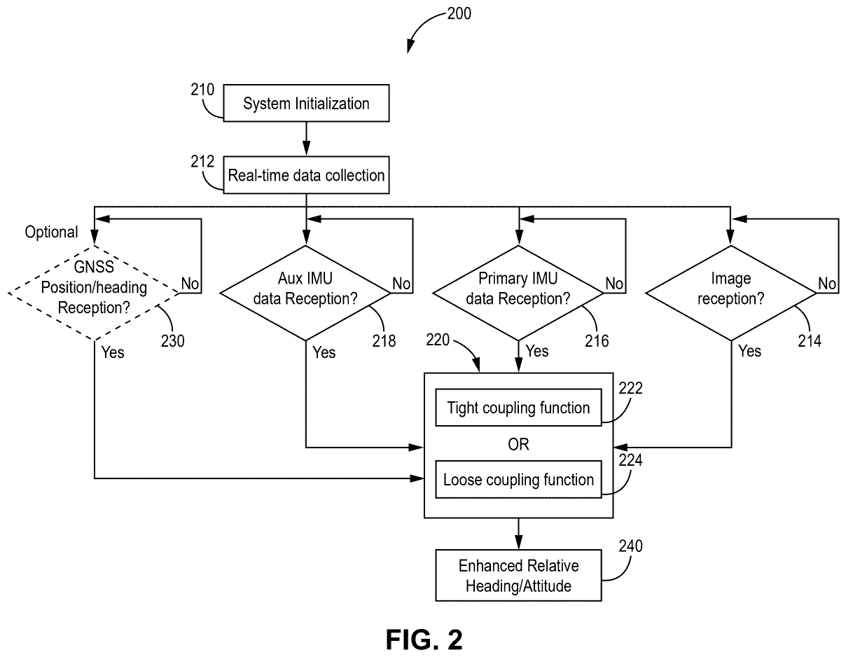

FIG. 2 is a flow diagram illustrating a method 200 of operation for a relative attitude measuring system, such as system 100 (FIG. 1). After system initialization (block 210), real-time data collection is performed (block 212). In particular, a determination is made whether there is an image reception by the camera of the visual IMU (block 214). If not, method 200 repeats the determination at block 214 until there is an image reception. For example, in response to determining that an image is received by the camera, method 200 sends image data corresponding to the received image to an onboard processing unit 220, which hosts a visual-inertial algorithm that can be performed by a tight coupling function 222 or a loose coupling function 224. A determination is also made whether there is primary IMU data reception (block 216), such as inertial data received by inertial sensors of the visual IMU. If not, method 200 repeats the determination at block 216 until there is primary IMU data reception. For example, in response to determining that inertial data is received by the inertial sensors of the visual IMU, method 200 sends the inertial data from the visual IMU to processing unit 220.

A determination is also made whether there is auxiliary IMU data reception (block 218), such as inertial data received by inertial sensors of the auxiliary IMU. If not, method 200 repeats the determination at block 218 until there is auxiliary IMU data reception. For example, in response to determining that inertial data is received by the inertial sensors of the auxiliary IMU, method 200 sends the inertial data from the auxiliary IMU to processing unit 220.

Optionally, when a GNSS receiver is employed, a determination can be made whether there is GNSS position/heading reception (block 230) such as position/heading data received by the GNSS receiver. If not, method 200 repeats the determination at block 230 until there is GNSS position/heading reception. For example, in response to determining that position/heading data is received by the GNSS receiver, method 200 sends the received position/heading data from the GNSS receiver to processing unit 220.

Once the data sent to processing unit 220 has been analyzed and processed by the tight coupling function 222 or the loose coupling function 224, an enhanced relative heading/attitude estimate (block 240) is computed and output by processing unit 220. The output data update rate depends on the input data update rate of the IMUs, and can work without any other data. The enhanced relative heading/attitude estimate can be sent from processing unit 220 to a vehicle control system, for example.

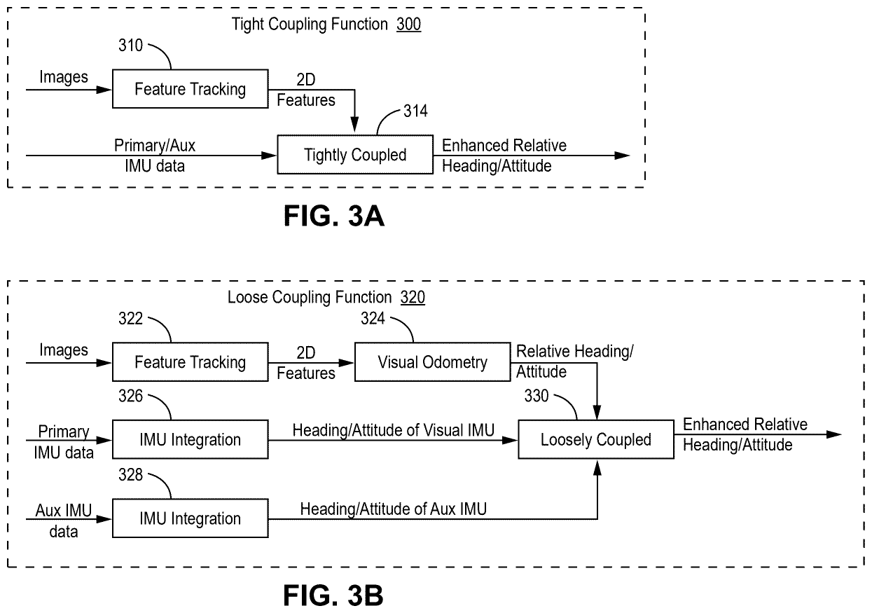

FIGS. 3A and 3B are flow diagrams of a tight coupling function 300 and a loose coupling function 320, such as performed in processing unit 220 (FIG. 2). Either the tight coupling function 300 or the loose coupling function 320 can be used depending on requirements with respect to accuracy, hardware resources, power consumption, etc., of a particular system.

As shown in FIG. 3A, the tight coupling function 300 includes a feature tracking module 310 that receives and process images from a primary (visual) IMU, and outputs two-dimensional (2D) features image data. The feature tracking in the images can be processed using either traditional computer vision algorithms or deep neural networks (DNNs). Traditional computer vision algorithms that can be used include histogram of oriented gradients (HOG), scale-invariant feature transform (SIFT), or the like. The DNNs that can be used include convolutional neural networks (CNNs), transformer-based networks, or the like.

The tight coupling function 300 also includes a tightly coupled module 314 that receives IMU data from the primary and auxiliary IMUs along with the 2D features image data from feature tracking module 310. The tightly coupled module 314 is operative to combine and process the IMU data and image data together in a single optimization filter. The tightly coupled module 314 then outputs an enhanced relative heading/attitude estimate.

As shown in FIG. 3B, the loose coupling function 320 includes a feature tracking module 322 that receives and process images from the primary (visual) IMU, and outputs 2D features image data. The feature tracking in the images can be processed using either traditional computer vision algorithms or DNNs, as described above.

A visual odometry module 324 receives the 2D features image data from feature tracking module 322, and outputs a relative heading/attitude estimate. A first IMU integration module 326 receives and processes IMU data from the primary IMU, and outputs a heading/attitude estimate for the visual IMU. A second IMU integration module 328 receives and processes IMU data from the auxiliary IMU, and outputs a heading/attitude estimate for the auxiliary IMU.

The loose coupling function 320 also includes a loosely coupled module 330 that receives the relative heading/attitude estimate from visual odometry module 324, and the heading/attitude estimates from first IMU integration module 326 and second IMU integration module 328. The loosely coupled module 330 is operative to combine and process the received heading/attitude estimates, and then output an enhanced relative heading/attitude estimate.

The processing unit and/or other computational devices used in the method and system described herein may be implemented using software, firmware, hardware, or appropriate combinations thereof. The processing unit and/or other computational devices may be supplemented by, or incorporated in, specially-designed application-specific integrated circuits (ASICs) or field programmable gate arrays (FPGAs). In some implementations, the processing unit and/or other computational devices may communicate through an additional transceiver with other computing devices outside of the navigation system, such as those associated with a management system or computing devices associated with other subsystems controlled by the management system. The processing unit and/or other computational devices can also include or function with software programs, firmware, or other computer readable instructions for carrying out various process tasks, calculations, and control functions used in the methods and systems described herein.

The methods described herein may be implemented by computer executable instructions, such as program modules or components, which are executed by at least one processor or processing unit. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer readable instructions. These instructions are typically stored on appropriate computer program products that include computer readable media used for storage of computer readable instructions or data structures. Such a computer readable medium may be available media that can be accessed by a general purpose or special purpose computer or processor, or any programmable logic device.

Suitable computer readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can be used to carry or store desired program code in the form of computer executable instructions or data structures.

### Example Embodiments

Example 1 includes a system comprising: a chassis of a vehicle; a movable member movably coupled to the chassis; a feature board attached to the vehicle; a visual inertial measurement unit (IMU) mounted on the vehicle, the visual IMU including a camera and a first set of inertial sensors, the camera configured to have a field of view that includes the feature board; an auxiliary IMU mounted on the vehicle, the auxiliary IMU including a second set of inertial sensors; and at least one processor onboard the vehicle, the at least one processor in operative communication with the visual IMU and the auxiliary IMU; wherein the at least one processor hosts a program module including a visual-inertial algorithm operative to perform a process that comprises: receive visual information from the camera, the visual information including features detected in images of the feature board captured by the camera; receive inertial measurements from visual IMU and the auxiliary IMU, the inertial measurements including acceleration data and angular rate data; and estimate orientation of the movable member with respect to the chassis by integrating the visual information with the inertial measurements.

Example 2 includes the system of Example 1, wherein: the feature board is attached to the chassis; the visual IMU is mounted on the movable member; and the auxiliary IMU is mounted on the chassis.

Example 3 includes the system of Example 1, wherein: the feature board is attached to the movable member; the visual IMU is mounted on the chassis; and the auxiliary IMU is mounted on the movable member.

Example 4 includes the system of any of Examples 1-3, wherein the vehicle is a construction machine vehicle comprising a dozer or an excavator.

Example 5 includes the system of any of Examples 1-4, wherein the movable member comprises a blade or a bucket, movably coupled to the chassis through a mechanical arm structure.

Example 6 includes the system of any of Examples 1-5, wherein the feature board has a flat surface including a chessboard or checkerboard pattern, a ChArUco pattern, or a circular grid.

Example 7 includes the system of any of Examples 1-6, further comprising: a global navigation satellite system (GNSS) receiver onboard the vehicle and communicatively coupled with the at least one processor; wherein the GNSS receiver is configured to provide position and heading information for the vehicle.

Example 8 includes the system of any of Examples 1-7, further comprising: a computer or controller onboard the vehicle and in operative communication with the at least one processor; wherein the at least one processor is operative to compute and output relative heading/attitude information, between the visual IMU and the auxiliary IMU, to the computer or controller by a common data interface.

Example 9 includes the system of any of Examples 1-8, wherein: the first set of inertial sensors of the visual IMU comprises one or more gyroscopes and one or more accelerometers; and the second set of inertial sensors of the auxiliary IMU comprises one or more gyroscopes and one or more accelerometers.

Example 10 includes the system of any of Examples 1-9, wherein the visual-inertial algorithm is performed by a tightly coupled process in which the visual information and the inertial measurements are combined and processed together in a single optimization filter to estimate the orientation of the movable member with respect to the chassis.

Example 11 includes the system of any of Examples 1-9, wherein the visual-inertial algorithm is performed by a loosely coupled process in which the visual information and the inertial measurements are processed independently to estimate the orientation of the movable member with respect to the chassis before these estimates are fused together.

Example 12 includes the system of any of Examples 1-11, wherein the visual information including features detected in images of the feature board are processed using an algorithm comprising a histogram of oriented gradients, or a scale-invariant feature transform.

Example 13 includes the system of any of Examples 1-11, wherein the visual information including features detected in images of the feature board are processed using one or more deep neural networks.

Example 14 includes the system of Example 13, wherein the one or more deep neural networks include a convolutional neural network, or a transformer-based network.

Example 15 includes a method comprising: providing a relative attitude measuring system comprising: a feature board attached to a movable member or a chassis of a vehicle; a visual inertial measurement unit (IMU) mounted on the vehicle, the visual IMU including a camera and a plurality of inertial sensors, the camera having a field of view that includes the feature board; an auxiliary IMU mounted on the vehicle and including a plurality of inertial sensors; and an onboard processing unit that hosts a visual-inertial algorithm that performs a tight coupling function or a loose coupling function; performing a real-time data collection process, comprising: determining whether an image is received by the camera of the visual IMU; in response to determining that an image is received by the camera, sending image data corresponding to the received image to the processing unit; determining whether inertial data is received by the inertial sensors of the visual IMU; in response to determining that inertial data is received by the inertial sensors of the visual IMU, sending the inertial data from the visual IMU to the processing unit; determining whether inertial data is received by the inertial sensors of the auxiliary IMU; and in response to determining that inertial data is received by the inertial sensors of the auxiliary IMU, sending the inertial data from the auxiliary IMU to the processing unit; wherein the data sent to the processing unit is analyzed and processed by the tight coupling function or the loose coupling function to compute an enhanced relative heading/attitude estimate; and sending the enhanced relative heading/attitude estimate from the processing unit to a control system for the vehicle.

Example 16 includes the method of Example 15, wherein: the relative attitude measuring system further comprises a global navigation satellite system (GNSS) receiver onboard the vehicle; and the real-time data collection process further comprises: determining whether position/heading data is received by the GNSS receiver; in response to determining that position/heading data is received by the GNSS receiver, sending the received position/heading data from the GNSS receiver to the processing unit.

Example 17 includes the method of any of Examples 15-16, wherein the tight coupling function comprises: a feature tracking module that receives and processes the image data from the visual IMU to produce two-dimensional (2D) features from the image data; and a tightly coupled module that receives the inertial data from the visual IMU and the auxiliary IMU, and the 2D features from the feature tracking module; wherein the tightly coupled module processes the 2D features and the inertial data together in a single optimization filter to compute the enhanced relative heading/attitude estimate.

Example 18 includes the method of any of Examples 15-16, wherein the loose coupling function comprises: a feature tracking module that receives and processes the image data from the visual IMU to produce 2D features from the image data; a visual odometry module that receives and processes the 2D features from the feature tracking module to compute a relative heading/attitude estimate; a first IMU integration module that receives and processes the inertial data from the visual IMU to compute a first heading/attitude estimate; a second IMU integration module that receives and processes the inertial data from the auxiliary IMU to compute a second heading/attitude estimate; and a loosely coupled module that receives the relative heading/attitude estimate from the visual odometry module, the first heading/attitude estimate from the first IMU integration module, and the second heading/attitude estimate from the second IMU integration module; wherein the loosely coupled module processes the relative heading/attitude estimate, the first heading/attitude estimate, and the second heading/attitude estimate, to compute the enhanced relative heading/attitude estimate.

Example 19 includes the method of any of Examples 15-18, wherein the vehicle is a construction machine vehicle comprising a dozer or an excavator.

Example 20 includes the method of any of Examples 15-19, wherein the movable member comprises a blade or a bucket, movably coupled to the chassis through a mechanical arm structure.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A system comprising:
a chassis of a vehicle;
a movable member movably coupled to the chassis;
a feature board attached to the vehicle;
a visual inertial measurement unit (IMU) mounted on the vehicle, the visual IMU including a camera and a first set of inertial sensors, the camera configured to have a field of view that includes the feature board;
an auxiliary IMU mounted on the vehicle, the auxiliary IMU including a second set of inertial sensors; and
at least one processor onboard the vehicle, the at least one processor in operative communication with the visual IMU and the auxiliary IMU;
wherein the at least one processor hosts a program module including a visual-inertial algorithm operative to perform a process that comprises:
receive visual information from the camera, the visual information including features detected in images of the feature board captured by the camera;
receive inertial measurements from the visual IMU and the auxiliary IMU, the inertial measurements including acceleration data and angular rate data; and
estimate orientation of the movable member with respect to the chassis by integrating the visual information with the inertial measurements.

2. The system of claim 1, wherein:
the feature board is attached to the chassis;
the visual IMU is mounted on the movable member; and
the auxiliary IMU is mounted on the chassis.

3. The system of claim 1, wherein:
the feature board is attached to the movable member;
the visual IMU is mounted on the chassis; and
the auxiliary IMU is mounted on the movable member.

4. The system of claim 1, wherein the vehicle is a construction machine vehicle comprising a dozer or an excavator.

5. The system of claim 4, wherein the movable member comprises a blade or a bucket, movably coupled to the chassis through a mechanical arm structure.

6. The system of claim 1, wherein the feature board has a flat surface including a chessboard or checkerboard pattern, a ChArUco pattern, or a circular grid.

7. The system of claim 1, further comprising:
a global navigation satellite system (GNSS) receiver onboard the vehicle and communicatively coupled with the at least one processor;
wherein the GNSS receiver is configured to provide position and heading information for the vehicle.

8. The system of claim 1, further comprising:
a computer or controller onboard the vehicle and in operative communication with the at least one processor;
wherein the at least one processor is operative to compute and output relative heading/attitude information, between the visual IMU and the auxiliary IMU, to the computer or controller by a common data interface.

9. The system of claim 1, wherein:
the first set of inertial sensors of the visual IMU comprises one or more gyroscopes and one or more accelerometers; and
the second set of inertial sensors of the auxiliary IMU comprises one or more gyroscopes and one or more accelerometers.

10. The system of claim 1, wherein the visual-inertial algorithm is performed by a tightly coupled process in which the visual information and the inertial measurements are combined and processed together in a single optimization filter to estimate the orientation of the movable member with respect to the chassis.

11. The system of claim 1, wherein the visual-inertial algorithm is performed by a loosely coupled process in which the visual information and the inertial measurements are processed independently to estimate the orientation of the movable member with respect to the chassis before these estimates are fused together.

12. The system of claim 1, wherein the visual information including features detected in images of the feature board are processed using an algorithm comprising a histogram of oriented gradients, or a scale-invariant feature transform.

13. The system of claim 1, wherein the visual information including features detected in images of the feature board are processed using one or more deep neural networks.

14. The system of claim 13, wherein the one or more deep neural networks include a convolutional neural network, or a transformer-based network.

15. A method comprising:
providing a relative attitude measuring system comprising:
a feature board attached to a movable member or a chassis of a vehicle;
a visual inertial measurement unit (IMU) mounted on the vehicle, the visual IMU including a camera and a plurality of inertial sensors, the camera having a field of view that includes the feature board;
an auxiliary IMU mounted on the vehicle and including a plurality of inertial sensors; and
an onboard processing unit that hosts a visual-inertial algorithm that performs a tight coupling function or a loose coupling function;
performing a real-time data collection process, comprising:
determining whether an image is received by the camera of the visual IMU;
in response to determining that an image is received by the camera, sending image data corresponding to the received image to the processing unit;
determining whether inertial data is received by the inertial sensors of the visual IMU;
in response to determining that inertial data is received by the inertial sensors of the visual IMU, sending the inertial data from the visual IMU to the processing unit;
determining whether inertial data is received by the inertial sensors of the auxiliary IMU; and
in response to determining that inertial data is received by the inertial sensors of the auxiliary IMU, sending the inertial data from the auxiliary IMU to the processing unit;
wherein the data sent to the processing unit is analyzed and processed by the tight coupling function or the loose coupling function to compute an enhanced relative heading/attitude estimate; and
sending the enhanced relative heading/attitude estimate from the processing unit to a control system for the vehicle.

16. The method of claim 15, wherein:
the relative attitude measuring system further comprises a global navigation satellite system (GNSS) receiver onboard the vehicle; and
the real-time data collection process further comprises:
determining whether position/heading data is received by the GNSS receiver; and
in response to determining that position/heading data is received by the GNSS receiver, sending the received position/heading data from the GNSS receiver to the processing unit.

17. The method of claim 15, wherein the tight coupling function comprises:
a feature tracking module that receives and processes the image data from the visual IMU to produce two-dimensional (2D) features from the image data; and
a tightly coupled module that receives the inertial data from the visual IMU and the auxiliary IMU, and the 2D features from the feature tracking module;
wherein the tightly coupled module processes the 2D features and the inertial data together in a single optimization filter to compute the enhanced relative heading/attitude estimate.

18. The method of claim 15, wherein the loose coupling function comprises:
a feature tracking module that receives and processes the image data from the visual IMU to produce 2D features from the image data;
a visual odometry module that receives and processes the 2D features from the feature tracking module to compute a relative heading/attitude estimate;
a first IMU integration module that receives and processes the inertial data from the visual IMU to compute a first heading/attitude estimate;
a second IMU integration module that receives and processes the inertial data from the auxiliary IMU to compute a second heading/attitude estimate; and
a loosely coupled module that receives the relative heading/attitude estimate from the visual odometry module, the first heading/attitude estimate from the first IMU integration module, and the second heading/attitude estimate from the second IMU integration module;
wherein the loosely coupled module processes the relative heading/attitude estimate, the first heading/attitude estimate, and the second heading/attitude estimate, to compute the enhanced relative heading/attitude estimate.

19. The method of claim 15, wherein the vehicle is a construction machine vehicle comprising a dozer or an excavator.

20. The method of claim 19, wherein the movable member comprises a blade or a bucket, movably coupled to the chassis through a mechanical arm structure.
